(19) United States
(12) Patent Application Publication
(10) Pub. No.: US 2010/0058737 A1
(43) Pub. Date: Mar. 11, 2010

(54) CONTROL DEVICE AND CONTROL METHOD OF HYBRID VEHICLE

(75) Inventors: Takeshi Harada, Nagoya-city (JP); Ikuo Ando, Toyota-city (JP); Daigo Ando, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/552,035

(22) Filed: Sep. 1, 2009

(30) Foreign Application Priority Data
Sep. 5, 2008 (JP) 2008-228785

(51) Int. Cl. F02D 41/04

(52) U.S. Cl. 60/273; 60/285

(57) ABSTRACT

In a hybrid vehicle using an engine as one of power sources, an ECU obtains catalyst temperature. The ECU performs a catalyst warm-up operation if the catalyst temperature is lower than first catalyst temperature necessary for exhaust gas purification during a continuous operation of the engine. The ECU performs intermittency prohibition operation for prohibiting an intermittent operation of the engine if the catalyst temperature is between the first catalyst temperature and second catalyst temperature necessary for the exhaust gas purification at starting of the engine. The ECU performs a normal operation for allowing the intermittent operation of the engine if the catalyst temperature is higher than the second catalyst temperature. Thus, deterioration of fuel consumption due to catalyst warm-up is inhibited while inhibiting deterioration of emission in the hybrid vehicle.

### CROSS REFERENCE TO RELATED APPLICATION

This application is based on and incorporates herein by reference Japanese Patent Application No. 2008-228785 filed on Sep. 5, 2008.

### BACKGROUND OF THE INVENTION

1. Field of the Invention

The present invention relates to a control technology of a hybrid vehicle that uses at least an internal combustion engine as a power source. In particular, the present invention relates to a technology for inhibiting deterioration of emission in exhaust gas of the internal combustion engine.

2. Description of Related Art

A hybrid vehicle that uses at least one of an engine and a motor as a power source has been put in practical use. Such the hybrid vehicle can run solely on the motor. Therefore, in some cases, the vehicle temporarily stops the engine even during the running of the vehicle. Such the operation will be referred to as an intermittent operation, hereafter. A fuel consumption and exhaust gas quantity of the engine are reduced by repeating the intermittent operation of the engine. Thus, air environment protection and fuel consumption improvement are realized.

A catalyst (a catalytic converter) for purifying the exhaust gas discharged from the engine is provided in the hybrid vehicle that uses the engine as one of the power sources. The catalyst removes the emission (i.e., hazardous materials such as HC, CO and NOx) in the exhaust gas.

There is a case where the deterioration of the emission becomes a problem when the intermittent operation of the engine is performed in such the hybrid vehicle. That is, since the catalyst is exposed to an oxygen-excess atmosphere due to the temporal stoppage of the engine, degradation of the catalyst tends to progress. Moreover, when the temporarily-stopped engine is restarted, relatively large quantity of the hazardous materials are contained in the exhaust gas due to incomplete combustion and the like immediately after the restart. In this case, if the function of the catalyst is insufficient, the emission of the exhaust gas discharged to an exterior is deteriorated. For example, JP-A-2004-124827 (Patent document 1) describes a technology for preventing the degradation of the catalyst and the deterioration of the emission of the exhaust gas resulting from the intermittent operation of the engine.

A power output device described in Patent document 1 has an engine, an external power imparting section, an exhaust gas purification section and a control section. The external power imparting section enables the intermittent operation of the engine. The exhaust gas purification section purifies the exhaust gas of the engine with the catalyst. The control section prohibits the intermittent operation of the engine when a purification rate of the catalyst is equal to or lower than a threshold value as control for reducing a hazardous material concentration in the exhaust gas. The purification rate of the catalyst is an index indicating a purification capacity of the catalyst.

The power output device described in Patent document 1 prohibits the intermittent operation of the engine when the purification rate of the catalyst is equal to or lower than the threshold value. Therefore, the progress of the degradation of the catalyst during the stoppage of the engine and the deterioration of the emission at the starting of the engine can be suppressed.

Normally, the exhaust gas at the starting of the engine contains larger quantity of HC than in the case where the engine is operated continuously. The catalyst has a characteristic that its purification capacity increases as the catalyst temperature increases. Therefore, catalyst temperature T2 necessary for the HC purification at the starting of the engine is higher than catalyst temperature T1 necessary for the HC purification during the continuous operation of the engine. In other words, when the catalyst temperature is lower than T1, the HC purification capacity of the catalyst is insufficient in both cases of the starting of the engine and the continuous operation of the engine. When the catalyst temperature is between T1 and T2, the HC purification capacity of the catalyst is insufficient at the starting of the engine. Therefore, if the intermittent operation is repeated when the catalyst temperature is lower than T2, the HC purification capacity of the catalyst is insufficient at least at the starting of the engine, and there is a concern that HC in the exhaust gas is discharged to the exterior.

Conventionally, in order to prevent such the problem, catalyst warm-up is performed until the catalyst temperature reaches T2 while prohibiting the intermittent operation, and the intermittent operation is allowed after the catalyst temperature reaches T2. The catalyst warm-up is control for increasing fuel supply quantity to the engine in order to raise the catalyst temperature quickly. Since large quantity of the fuel is consumed to raise the catalyst temperature during the catalyst warm-up, the catalyst warm-up has been a cause of the deterioration of the fuel consumption. However, nothing was taken into account in the technology of Patent document 1 about a technology for inhibiting the fuel consumption deterioration due to the catalyst warm-up.

### SUMMARY OF THE INVENTION

It is an object of the present invention to provide a control device and a control method capable of inhibiting deterioration of a fuel consumption due to catalyst warm-up while inhibiting deterioration of emission in a hybrid vehicle that uses an internal combustion engine as one of power sources.

According to a first example aspect of the present invention, a control device controls a hybrid vehicle using an internal combustion engine, which purifies exhaust gas with a catalyst, as at least one power source. The hybrid vehicle can run by performing an intermittent operation for temporarily stopping the internal combustion engine. The catalyst has a characteristic that second temperature of the catalyst necessary for exhaust gas purification at starting of the internal combustion engine is higher than first temperature of the catalyst necessary for the exhaust gas purification during a continuous operation of the internal combustion engine. The control device has an obtaining section that obtains temperature of the catalyst. The control device has a control section that controls the internal combustion engine in either one of modes of a normal operation, a warm-up operation and an intermittency prohibition operation based on the temperature of the catalyst. The normal operation allows the intermittent operation. The warm-up operation increases fuel supply quantity to the internal combustion engine from the fuel supply quantity of the normal operation while prohibiting the intermittent operation. The intermittency prohibition operation prohibits the intermittent operation while setting the fuel supply quantity to be the same as the fuel supply quantity of the normal operation. The control section performs the warm-up operation if the temperature of the catalyst is lower than the first temperature. The control section performs the intermittency prohibition operation if the temperature of the catalyst is between the first temperature and the second temperature. The control section performs the normal operation if the temperature of the catalyst is higher than the second temperature.

According to a second example aspect of the present invention, in the above control device, the control section controls the internal combustion engine in either one of the modes at starting of the hybrid vehicle

According to a third example aspect of the present invention, in the above control device, the control section performs the intermittency prohibition operation continuously until the temperature of the catalyst reaches the second temperature if the temperature of the catalyst at starting of the hybrid vehicle is between the first temperature and the second temperature.

According to a fourth example aspect of the present invention, in the above control device, the control section performs the warm-up operation continuously until the temperature of the catalyst reaches the first temperature and performs the intermittency prohibition operation continuously until the temperature of the catalyst reaches the second temperature if the temperature of the catalyst at starting of the hybrid vehicle is lower than the first temperature.

According to a fifth example aspect of the present invention, the above control device further has a sensor for sensing coolant temperature of the internal combustion engine and a sensor for sensing intake air quantity of the internal combustion engine. The obtaining section estimates the temperature of the catalyst based on the coolant temperature and the intake air quantity.

According to a sixth example aspect of the present invention, in the above control device, the obtaining section estimates the temperature of the catalyst based on the coolant temperature at starting of the hybrid vehicle and an integration value of the intake air quantity after the starting of the hybrid vehicle.

According to a seventh example aspect of the present invention, a control method provides actions or functions similar to those of the control device according to the first example aspect of the present invention.

According to the present invention, deterioration of a fuel consumption due to catalyst warm-up can be inhibited while inhibiting deterioration of emission.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application In the drawings:

FIG. 1 is a diagram showing a structure of a vehicle mounted with a control device according to an embodiment of the present invention;

FIG. 2 is a diagram showing a structure of an engine mounted to the vehicle according to the embodiment;

FIG. 3 is a functional block diagram of the control device according to the embodiment;

FIG. 4 is a flowchart showing a control structure of the control device according to the embodiment;

FIG. 5 is a timing chart showing catalyst temperature, engine rotation speed and generation quantity of hydrocarbon controlled by the control device according to the embodiment;

FIG. 6 is a flowchart showing a control structure of a control device according to a modified example of the embodiment; and

FIG. 7 is a map stored in the control device according to the modified example of the embodiment.

### DETAILED DESCRIPTION OF EXAMPLE EMBODIMENT

Next, an embodiment of the present invention will be described with reference to the drawings.

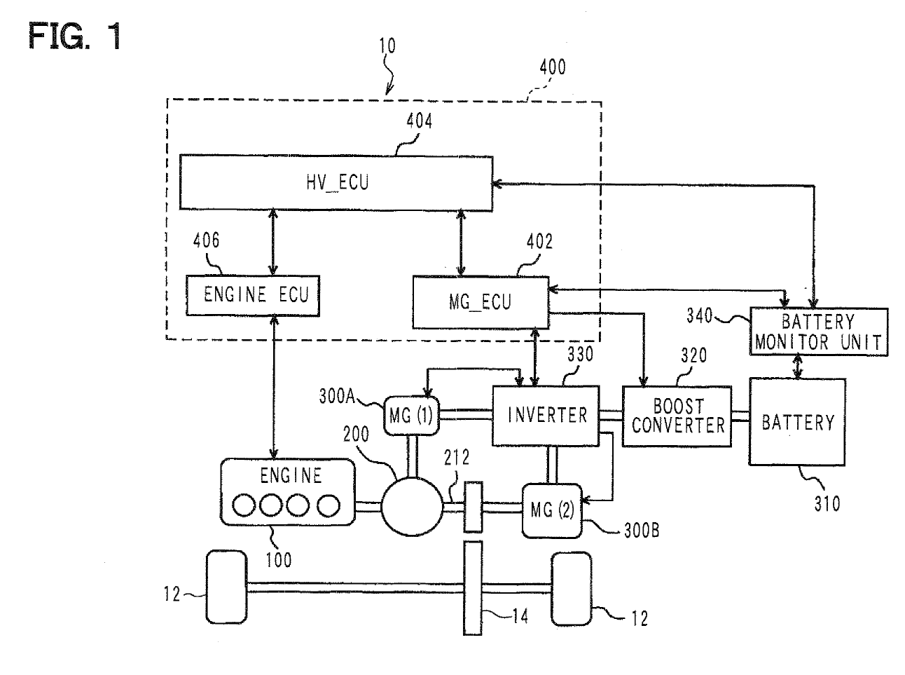

A hybrid vehicle 10 mounted with a control device according to the present embodiment will be explained with reference to FIG. 1. The vehicle, to which the present invention can be applied, is not limited to the hybrid vehicle 10 shown in FIG. 1. The present invention can be also applied to any vehicle having a different construction as long as the vehicle can perform an intermittent operation of an engine during running of the vehicle.

The hybrid vehicle 10 has an engine 100 and motor generators 300A, 300B (MG(1) 300A and MG(2) 300B). In the following description, each of the motor generators 300A, 300B will be referred to also as a motor generator 300 when explanation is given without discriminating between the motor generators 300A, 300B. Regenerative braking is performed when the motor generator 300 functions as a generator. When the motor generator 300 functions as the generator, a kinetic energy of the vehicle is converted into an electrical energy and a regenerative braking force (regenerative brake) occurs, and the vehicle is decelerated.

The hybrid vehicle 10 runs on power of at least either one of the engine 100 and the motor generator 300. That is, the hybrid vehicle 10 can run solely on the power of the motor generator 300.

The hybrid vehicle 10 further has a speed reducer 14, a power division mechanism 200, a battery 310, an inverter 330, an engine ECU 406, an MG_ECU 402, an HV_ECU 404, and the like. The speed reducer 14 transmits the power generated in the engine 100 or the motor generator 300 to driving wheels 12 or transmits drive of the driving wheels 12 to the engine 100 or the motor generator 300. The power division mechanism 200 distributes the power generated by the engine 100 to an output shaft 212 and the MG(1) 300A. The battery 310 is charged with an electric power for driving the motor generator 300. The inverter 330 performs current control by converting direct current of the battery 310 and alternating current of the motor generator 300. The engine ECU 406 controls an operation state of the engine 100. The MG_ECU 402 controls a charge-discharge state and the like of the motor generator 300, the inverter 330 and the battery 310 in accordance with a state of the hybrid vehicle 10. The HV_ECU 404 performs mutual management and control with the engine ECU 406, the MG_ECU 402 and the like to control the entire hybrid system such that the hybrid vehicle 10 can run most efficiently.

A boost converter 320 is provided between the battery 310 and the inverter 330. A rated voltage of the battery 310 is lower than a rated voltage of the motor generator 300. Therefore, when the electric power is supplied from the battery 310 to the motor generator 300, the voltage of the electric power is boosted by the boost converter 320.

In FIG. 1, the multiple ECUs are provided as separate bodies. Alternatively, the two or more ECUs may be integrated and provided as a single ECU. For example, as shown by a broken line in FIG. 1, the MG_ECU 402, the HV_ECU 404 and the engine ECU 406 may be integrated into an ECU 400. In the following explanation, the MG_ECU 402, the HV_ECU 404 and the engine ECU 406 will be referred to as the ECU 400 without discriminating therebetween.

Signals are inputted to the ECU 400 from a vehicle speed sensor, an accelerator position sensor, a throttle position sensor, an MG(1) rotation speed sensor, an MG(2) rotation speed sensor, an engine rotation speed sensor (which are not shown), and a battery monitor unit 340 that monitors states of the battery 310 such as a voltage value VB between terminals, a battery current value IB and battery temperature TB.

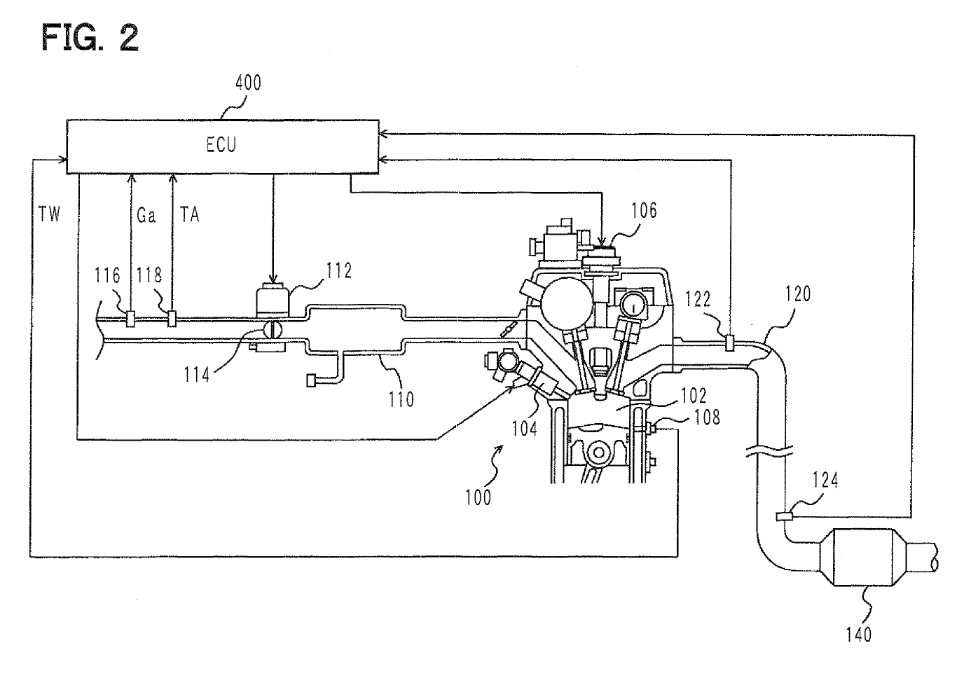

Next, the engine 100 will be explained with reference to FIG. 2. In the engine 100, an air suctioned from an air cleaner (not shown) flows through an intake pipe 110 and is introduced into a combustion chamber 102 of the engine 100. Air quantity introduced into the combustion chamber 102 is adjusted by an opening degree of a throttle valve 114 (i.e., a throttle opening). The throttle opening is controlled by a throttle motor 112 operating based on a signal from the ECU 400.

Fuel is stored in a fuel tank (not shown) and is injected from an injector 104 into the combustion chamber 102 by a fuel pump (not shown). A mixture gas of the air introduced from the intake pipe 110 and the fuel injected from the injector 104 is ignited by an ignition coil 106 and combusted. The ignition coil 106 is controlled by a control signal from the ECU 400.

Exhaust gas after the combustion of the mixture gas passes through a catalyst 140 provided in an exhaust pipe 120 and is discharged to the atmosphere.

The catalyst 140 is a three-way catalyst that performs purification processing of emission (hazardous materials such as hydrocarbon (HC), carbon monoxide (CO) and nitrogen oxides (NOx)) contained in the exhaust gas. Precious metals containing platinum, palladium and rhodium are supported on a base made of alumina in the catalyst 140. The catalyst 140 can cause oxidation reactions of the hydrocarbon and the carbon monoxide and reduction reactions of the nitrogen oxides at the same time. The catalyst 140 has a characteristic that an exhaust gas purification capacity thereof increases as temperature thereof increases.

Signals are inputted to the ECU 400 from an engine coolant temperature sensor 108, an airflow meter 116; an intake temperature sensor 118, an air-fuel ratio sensor 122 and an oxygen sensor 124.

The engine coolant temperature sensor 108 senses temperature TW of an engine coolant (i.e., engine coolant temperature TW). The airflow meter 116 is provided upstream of the throttle valve 114 in the intake pipe 110. The airflow meter 116 senses intake air quantity Ga, i.e., air quantity suctioned by the engine 100 per unit time. The intake temperature sensor 118 senses temperature TA of the intake air (i.e., intake air temperature TA). The air-fuel ratio sensor 122 senses a ratio between the air and the fuel in the exhaust gas. The oxygen sensor 124 senses an oxygen concentration in the exhaust gas. These sensors transmit the signals indicating the sensing results to the ECU 400.

The ECU 400 controls devices to realize a desired running state of the hybrid vehicle 10 based on the signals sent from the respective sensors and based on maps and programs stored in ROM (Read Only Memory).

For example, the ECU 400 controls the ignition coil 106 to achieve proper ignition timing and controls the throttle motor 112 to achieve a proper throttle opening based on the signals from the sensors.

The ECU 400 controls the injector 104 to achieve proper fuel injection quantity based on the signals from the sensors.

When the engine 100 is operated continuously, the ECU 400 performs feedback control of the fuel injection quantity based on the signals from the air-fuel ratio sensor 122 and the oxygen sensor 124 such that the air-fuel ratio becomes a proper value. When the engine 100 is started, in order to stabilize the combustion immediately after the starting, the ECU 400 increases the fuel injection quantity from the quantity in the case where the engine 100 is operated continuously (i.e., the quantity in the case where the feedback control is performed to conform the air-fuel ratio to the proper value as mentioned above).

Thus, when the engine 100 is started, the fuel injection quantity is increased from the fuel injection quantity of the continuous operation. Therefore, the exhaust gas at the starting of the engine 100 contains larger quantity of HC than in the case of the continuous operation. As mentioned above, the catalyst 140 has the characteristic that its exhaust gas purification capacity increases as the catalyst temperature increases. In other words, the catalyst 140 has a characteristic that T2 is higher than T1, wherein T1 represents the catalyst temperature necessary for the HC purification during the continuous operation of the engine 100 and T2 is the catalyst temperature necessary for the HC purification at the starting of the engine 100.

The hybrid vehicle 10 according to the present embodiment can run solely on the power of the motor generator 300 as mentioned above. Therefore, intermittent operation for temporarily stopping the engine 100 can be performed, for example, when a condition that SOC (State Of Charge) of the battery 310 is sufficiently high is satisfied.

However, if the intermittent operation is repeated (i.e., if the starting of the engine 100 is repeated) when the temperature of the catalyst 140 is lower than T2, there is a concern that the purification capacity of the catalyst 140 has not reached the capacity necessary at the starting of the engine and the HC component is discharged to an exterior.

In order to prevent such the problem, conventionally, the intermittent operation was prohibited and control for quickly raising the temperature of the catalyst 140 by increasing the fuel injection quantity to the engine 100 (i.e., a catalyst warm-up operation) was performed continuously until the temperature of the catalyst 140 increases to T2. Then, the intermittent operation was allowed after the temperature of the catalyst 140 reaches T2. However, since large quantity of the fuel is consumed to raise the catalyst temperature during the catalyst warm-up operation, the above scheme can cause deterioration of fuel consumption.

The present invention is characterized in following points. That is, time for continuing the catalyst warm-up operation is shortened to time necessary for the temperature of the catalyst 140 to reach T1 (<T2). The catalyst warm-up is not performed until the temperature of the catalyst 140 reaches T2. Instead, the intermittent operation is prohibited until the temperature of the catalyst 140 reaches T2. In this way, the present invention aims to inhibit the deterioration of the fuel consumption due to the catalyst warm-up operation while inhibiting the deterioration of the emission.

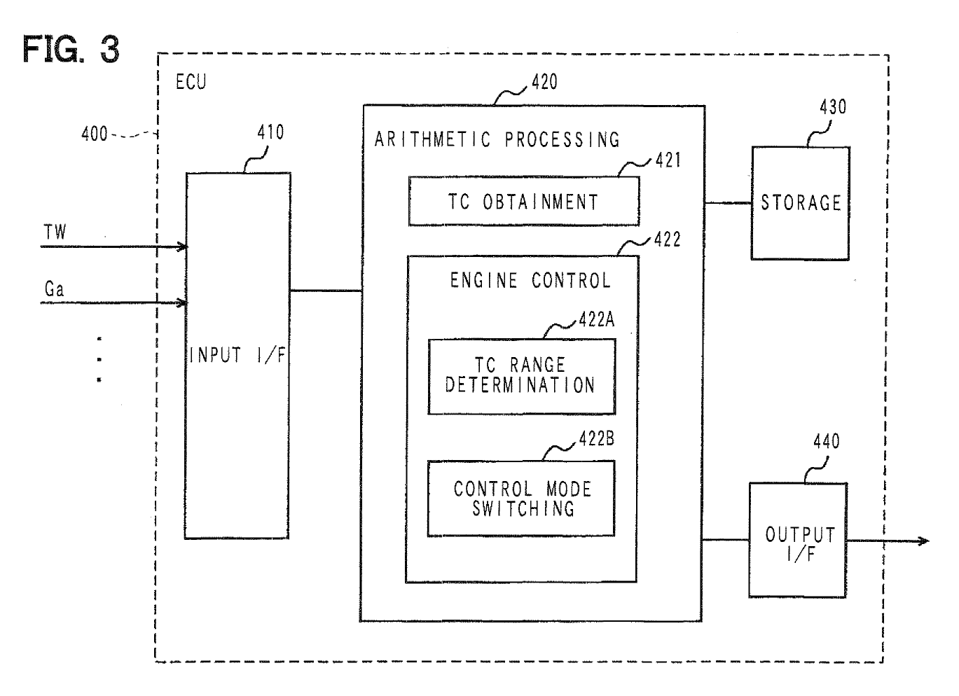

FIG. 3 is a functional block diagram showing the ECU 400 as a control device according to the present embodiment. The ECU 400 has an input interface 410, an arithmetic processing section 420, a storage section 430 and an output interface 440.

The input interface 410 receives the engine coolant temperature TW from the engine coolant temperature sensor 108, the intake air quantity Ga from the airflow meter 116 and the sensing results from the other sensors and transmits them to the arithmetic processing section 420.

The storage section 430 stores various kinds of information, programs, threshold values, maps and the like. The data are read from and stored in the storage section 430 by the arithmetic processing section 420 when needed.

The arithmetic processing section 420 has a catalyst temperature obtaining section 421 and an engine control section 422. The catalyst temperature obtaining section 421 obtains temperature TC of the catalyst 140 (i.e., catalyst temperature TC). The catalyst temperature obtaining section 421 estimates the catalyst temperature TC based on parameters having close relationship with the temperature of the catalyst 140 (for example, the engine coolant temperature TW, an integration value of the intake air quantity Ga, the engine rotation speed NE and the like).

For example, the catalyst temperature obtaining section 421 estimates a soak time based on the engine coolant temperature TWst as of the starting of the vehicle. The soak time is time from the previous stoppage to the present starting. The catalyst temperature obtaining section 421 estimates the catalyst temperature TCst as of the starting of the vehicle in accordance with the soak time and stores the catalyst temperature TCst in the storage section 430. Furthermore, the catalyst temperature obtaining section 421 calculates an integration value of the intake air quantity Ga after the starting of the vehicle and estimates catalyst temperature increase amount ΔTC after the starting of the vehicle based on the integration value. The catalyst temperature obtaining section 421 estimates the catalyst temperature TC by adding the catalyst temperature increase amount ΔTC to the catalyst temperature TCst as of the starting of the vehicle (i.e., TC=TCst+ΔTC). The estimation method of the catalyst temperature TC is not limited to the above method. If a sensor capable of directly sensing the temperature of the catalyst 140 is provided, a sensor output value of the sensor may be obtained as the catalyst temperature TC.

The engine control section 422 outputs commands for controlling the engine 100 in either one of operation modes of a normal operation, a catalyst warm-up operation and an intermittency prohibition operation to the respective devices (the injector 104, the ignition coil 106, the throttle motor 112 and the like) via the output interface 440. The normal operation allows the intermittent operation. The catalyst warm-up operation prohibits the intermittent operation and increases the fuel injection quantity to the engine 100 from the fuel injection quantity of the normal operation. The intermittency prohibition operation sets the fuel injection quantity to the engine 100 to be the same as the fuel injection quantity of the normal operation and prohibits the intermittent operation.

The engine control section 422 has a catalyst temperature range determination section 422A and a control mode switching section 422B.

The catalyst temperature range determination section 422A determines a temperature range, to which the catalyst temperature TC belongs, out of a low temperature range lower than the catalyst temperature T1 necessary for the HC purification during the engine continuous operation, a high temperature range higher than the catalyst temperature T2 (>T1) necessary for the HC purification at the starting of the engine, and an intermediate temperature range between T1 and T2.

The control mode switching section 422B switches the control mode of the engine 100 based on the determination result of the catalyst temperature range determination section 422A. The control mode switching section 422B performs the warm-up operation when the catalyst temperature TC is lower than T1. The control mode switching section 422B performs the intermittency prohibition operation when the catalyst temperature TC is in the range between T1 and T2. The control mode switching section 422B performs the normal operation when the catalyst temperature TC is higher than T2.

The explanation of the present embodiment is given on the assumption that the catalyst temperature obtaining section 421 and the engine control section 422 function as software, which is realized when CPU as the arithmetic processing section 420 executes the programs stored in the storage section 430. Alternatively, the catalyst temperature obtaining section 421 and the engine control section 422 may be realized with hardware. Such the programs are recorded on a storage medium and mounted in the vehicle.

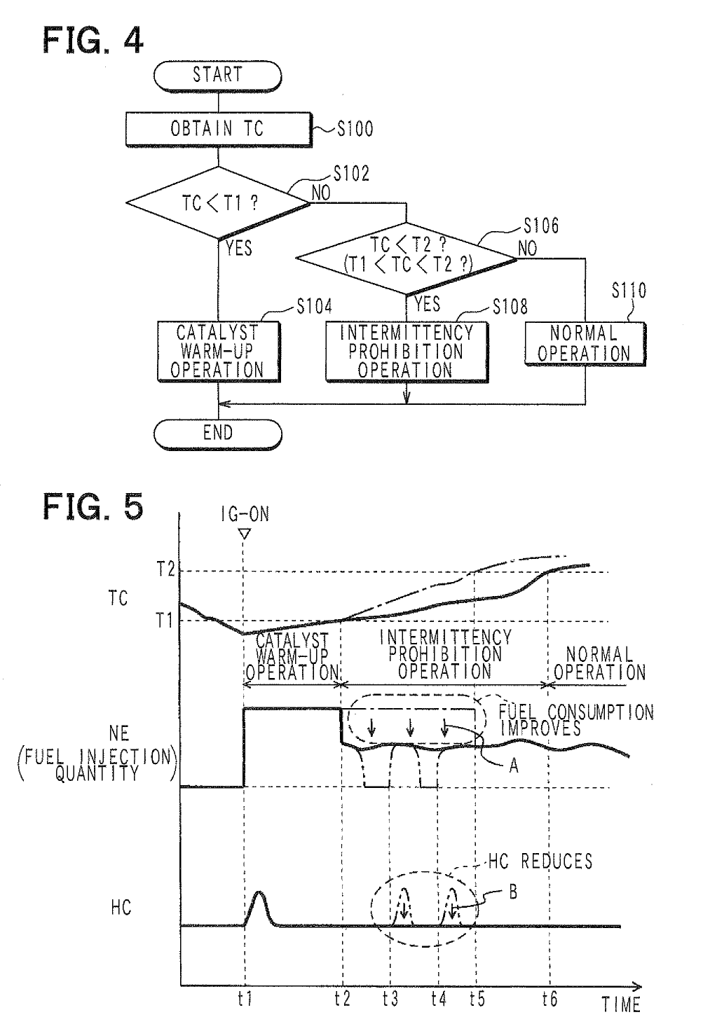

Hereafter control structure of a program executed by the ECU 400, which is the control device according to the present embodiment, will be explained with reference to FIG. 4. The program is repeatedly executed in a predetermined time cycle.

The ECU 400 obtains the catalyst temperature TC in S100 (S means “Step”). For example, as mentioned above, the ECU 400 estimates the catalyst temperature TC based on the engine coolant temperature TW and the intake air quantity Ga.

In S102, the ECU 400 determines whether the catalyst temperature TC is lower than the catalyst temperature T1 necessary for the HC purification during the continuous operation of the engine 100. If it is determined that the catalyst temperature TC is lower than T1 (S102: YES), the processing is shifted to S104. Otherwise (S102: NO), the processing is shifted to S106.

The ECU 400 performs the catalyst warm-up operation in S104. During the catalyst warm-up operation, as mentioned above, the intermittent operation of the engine 100 is prohibited and the fuel injection quantity to the engine 100 is increased from the fuel injection quantity of the normal operation.

In S106, the ECU 400 determines whether the catalyst temperature TC is lower than the catalyst temperature T2 necessary for the HC purification at the starting of the engine. That is, the ECU 400 determines whether the catalyst temperature TC is between T1 and T2. If it is determined that the catalyst temperature TC is between T1 and T2 (S106: YES), the processing is shifted to S108. Otherwise (S106: NO), the processing is shifted to S110.

The ECU 400 performs the intermittency prohibition operation in S108. During the intermittency prohibition operation, as mentioned above, the fuel injection quantity to the engine 100 is set to be the same as the fuel injection quantity of the normal operation and the intermittent operation of the engine 100 is prohibited.

The ECU 400 performs the normal operation in S110. During the normal operation, as mentioned above, the intermittent operation of the engine 100 is allowed. That is, the engine 100 is stopped every time a predetermined condition (for example, a condition that SOC of the battery 310 is higher than a predetermined value) is established, and the engine 100 is started every time the establishment of the predetermined condition disappears.

Next, an operation of the ECU 400, which is the control device according to the present embodiment, based on the structure and the flowchart described above will be explained with reference to FIG. 5.

FIG. 5 is a timing chart showing the catalyst temperature TC, the engine rotation speed NE and the generation amount of the hydrocarbon (HC) in the case where the driver performs ignition-on (IG-ON) to start the hybrid vehicle 10 at time t1. The engine rotation speed NE in FIG. 5 corresponds to the fuel injection quantity of the engine 100.

As shown in FIG. 5, the catalyst temperature TC at the time t1 is lower than T1 (S102: YES). Therefore, the catalyst warm-up operation is performed in S104, and the fuel injection quantity to the engine 100 is increased from the fuel injection quantity of the normal operation.

Conventionally, as shown by a chained line in FIG. 5, the catalyst warm-up operation has been performed continuously until time t5, at which the catalyst temperature TC reaches T2.

In contrast, in the present embodiment, the operation is switched from the catalyst warm-up operation to the intermittency prohibition operation at time t2 (S106: YES, S108), at which the catalyst temperature TC reaches T1 (S102: NO). Accordingly, the catalyst warm-up operation time is shortened and the fuel consumed to raise the catalyst temperature TC can be reduced as compared to the conventional technology (refer to arrow marks A in FIG. 5). Thus, the fuel consumption deterioration due to the catalyst warm-up is inhibited.

However, if the starting of the engine 100 due to the intermittent operation is repeated at time t3 and time t4 before the catalyst temperature TC reaches T2, large quantity of HC exceeding the purification capacity of the catalyst 140 is generated every time the starting is repeated (refer to a chain double-dashed line in FIG. 5).

Therefore, in the present embodiment, the intermittency prohibition operation is performed continuously (S106: YES, S108) until time t6, at which the catalyst temperature TC reaches T2. The normal operation is performed (S106: NO, S110) after the time t6, at which the catalyst temperature TC reaches T2. Thus, the engine 100 is operated continuously (i.e., the engine 100 is not started) until the time t6, at which the catalyst temperature TC reaches T2. Therefore, the generation of the large quantity of HC exceeding the purification capacity of the catalyst 140 can be inhibited (refer to arrow marks B in FIG. 5). Accordingly, the deterioration of the emission can be inhibited.

As mentioned above, the control device according to the present embodiment performs the intermittency prohibition operation instead of the catalyst warm-up operation when the catalyst temperature is between the temperature, which is necessary for the HC purification during the continuous operation of the engine 100, and the temperature, which is necessary for the HC purification at the starting of the engine. In this way, the present invention can inhibit the deterioration of the fuel consumption due to the catalyst warm-up while inhibiting the deterioration of the emission.

Hereafter, a modified example of the above embodiment will be described. In the above embodiment, the catalyst temperature TC is calculated based on the engine coolant temperature TW and the integration value of the intake air quantity Ga, and the operation mode of the engine 100 is switched based on the calculation result. In regard to this point, the modified example switches the operation mode of the engine 100 directly based on the engine coolant temperature TW and the integration value of the intake air quantity Ga without calculating the catalyst temperature TC. The other constructions of the control block and the flowchart are the same as those of the above embodiment, so the explanation thereof is not repeated here.

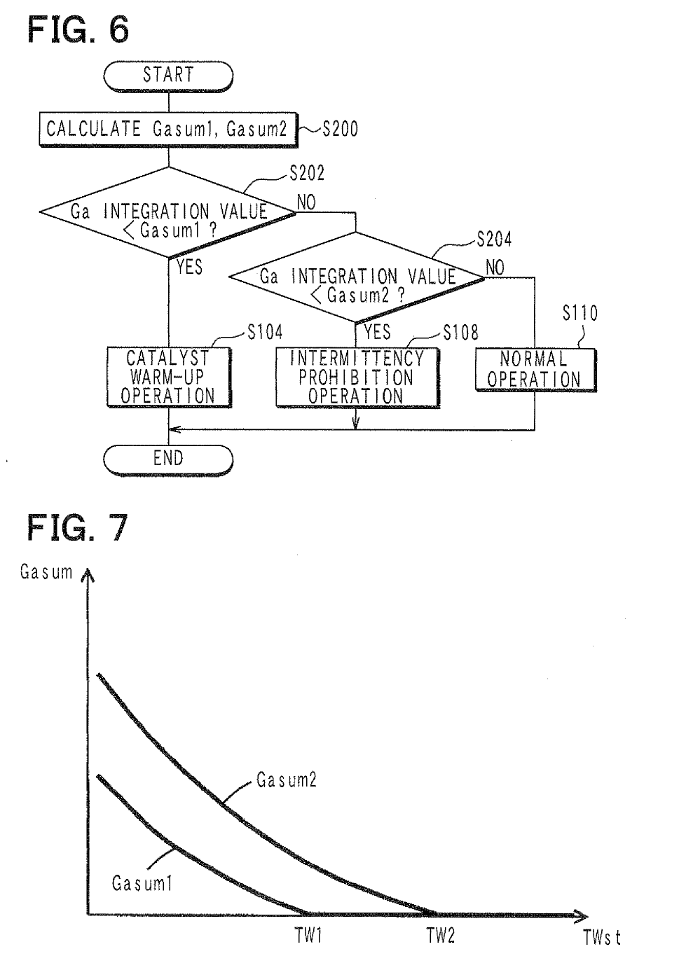

Hereafter, a control structure of a program executed by an ECU 400 according to the present modified example will be explained with reference to FIG. 6. The same step number is used for the same processing shown in FIGS. 4 and 6, and the explanation thereof is not repeated here.

In S200, the ECU 400 defines the engine coolant temperature TW sensed at the starting of the vehicle as TWst. In S200, the ECU 400 calculates integration air quantity Gasum1 necessary for raising the temperature of the catalyst 140 to T1 and integration air quantity Gasum2 necessary for raising the temperature of the catalyst 140 to T2 based on TWst and a map shown in FIG. 7.

In the map shown in FIG. 7, Gasum1 and Gasum2 are set by using the engine coolant temperature TWst at the starting of the vehicle as a parameter. The map of FIG. 7 is stored in the storage section 430 beforehand. Considering that the soak time is longer and the temperature of the catalyst 140 is lower as TWst is lower, the values of Gasum1 and Gasum2 are set to be larger as TWst is lower in the map of FIG. 7. In a range where TWst>TW2, the temperature of the catalyst 140 is already higher than T2 at the starting of the vehicle, so Gasum1=Gasum2=0. In a range where TW1<TWst<TW2, the temperature of the catalyst 140 is between T1 and T2 at the starting of the vehicle, so Gasum1=0 and Gasum2>0. In a range where TWst<TW1, the temperature of the catalyst 140 is lower than T1 at the starting of the vehicle, so Gasum1>0 and Gasum2>0.

In S202, the ECU 400 calculates the integration value of the intake air quantity Ga after the starting of the vehicle and determines whether the integration value of the intake air quantity Ga is smaller than Gasum1. If the integration value of the intake air quantity Ga is smaller than Gasum1 (S202: YES), the processing is shifted to S104. Otherwise (S202: NO), the processing is shifted to S204.

In S204, the ECU 400 determines whether the integration value of the intake air quantity Ga is smaller than Gasum2 (i.e., whether the integration value of the intake air quantity Ga is between Gasum1 and Gasum2). If the integration value of the intake air quantity Ga is smaller than Gasum2 (S204: YES), the processing is shifted to S108. Otherwise (S204: NO), the processing is shifted to S110.

In this way, in the present modified example, the switching among the warm-up operation, the intermittency prohibition operation and the normal operation can be performed appropriately based on the engine coolant temperature TW (i.e., the engine coolant temperature TWst at the starting of the vehicle) and the intake air quantity Ga (i.e., the integration value of the intake air quantity Ga from the starting of the vehicle), without performing the calculation of the catalyst temperature TC.

While the invention has been described in connection with what is presently considered to be the most practical and preferred embodiments, it is to be understood that the invention is not to be limited to the disclosed embodiments but on the contrary, is intended to cover various modifications and equivalent arrangements included within the spirit and scope of the appended claims.

What is claimed is:

1. A control device of a hybrid vehicle using an internal combustion engine, which purifies exhaust gas with a catalyst, as at least one power source, wherein the hybrid vehicle can run by performing an intermittent operation for temporarily stopping the internal combustion engine and the catalyst has a characteristic that second temperature of the catalyst necessary for exhaust gas purification at starting of the internal combustion engine is higher than first temperature of the catalyst necessary for the exhaust gas purification during a continuous operation of the internal combustion engine, the control device comprising:
an obtaining section that obtains temperature of the catalyst; and
a control section that controls the internal combustion engine in either one of modes of a normal operation, a warm-up operation and an intermittency prohibition operation based on the temperature of the catalyst, wherein the normal operation allows the intermittent operation, the warm-up operation increases fuel supply quantity to the internal combustion engine from the fuel supply quantity of the normal operation while prohibiting the intermittent operation, and the intermittency prohibition operation prohibits the intermittent operation while setting the fuel supply quantity to be the same as the fuel supply quantity of the normal operation, wherein
the control section performs the warm-up operation if the temperature of the catalyst is lower than the first temperature,
the control section performs the intermittency prohibition operation if the temperature of the catalyst is between the first temperature and the second temperature, and
the control section performs the normal operation if the temperature of the catalyst is higher than the second temperature.

2. The control device as in claim 1, wherein
the control section controls the internal combustion engine in either one of the modes at starting of the hybrid vehicle.

3. The control device as in claim 1, wherein
the control section performs the intermittency prohibition operation continuously until the temperature of the catalyst reaches the second temperature if the temperature of the catalyst at starting of the hybrid vehicle is between the first temperature and the second temperature.

4. The control device as in claim 1, wherein
the control section performs the warm-up operation continuously until the temperature of the catalyst reaches the first temperature and performs the intermittency prohibition operation continuously until the temperature of the catalyst reaches the second temperature if the temperature of the catalyst at starting of the hybrid vehicle is lower than the first temperature.

5. The control device as in claim 1, further comprising:
a sensor for sensing coolant temperature of the internal combustion engine; and
a sensor for sensing intake air quantity of the internal combustion engine, wherein
the obtaining section estimates the temperature of the catalyst based on the coolant temperature and the intake air quantity.

6. The control device as in claim 5, wherein
the obtaining section estimates the temperature of the catalyst based on the coolant temperature at starting of the hybrid vehicle and an integration value of the intake air quantity after the starting of the hybrid vehicle.

7. A control method performed by a control device of a hybrid vehicle using an internal combustion engine, which purifies exhaust gas with a catalyst, as at least one power source, wherein the hybrid vehicle can run by performing an intermittent operation for temporarily stopping the internal combustion engine and the catalyst has a characteristic that second temperature of the catalyst necessary for exhaust gas purification at starting of the internal combustion engine is higher than first temperature of the catalyst necessary for the exhaust gas purification during a continuous operation of the internal combustion engine, the control method comprising:
an obtaining step for obtaining temperature of the catalyst; and
a controlling step for controlling the internal combustion engine in either one of modes of a normal operation mode, a warm-up operation mode and an intermittency prohibition operation mode based on the temperature of the catalyst, wherein the normal operation allows the intermittent operation, the warm-up operation increases fuel supply quantity to the internal combustion engine from the fuel supply quantity of the normal operation while prohibiting the intermittent operation, and the intermittency prohibition operation prohibits the intermittent operation while setting the fuel supply quantity to be the same as the fuel supply quantity of the normal operation, wherein
the controlling step performs the warm-up operation if the temperature of the catalyst is lower than the first temperature,
the controlling step performs the intermittency prohibition operation if the temperature of the catalyst is between the first temperature and the second temperature, and
the controlling step performs the normal operation if the temperature of the catalyst is higher than the second temperature.
